(19) United States
(12) Patent Application Publication
(10) Pub. No.: US 2019/0207716 A1
(43) Pub. Date: Jul. 4, 2019

(54) Video encoding apparatus for rearranging packet transmission order and procedure of operating video encoding apparatus

(71) Applicant: OPEN STACK, INC., Gyeonggi-do (KR)

(72) Inventors: Jae Guon Nam, Gyeonggi-do (KR); Ho Jin Choi, Gyeonggi-do (KR); Sun Min Lee, Gyeonggi-do (KR); Shin Hyug Kang, Gyeonggi-do (KR); Chan Hyuk Ryu, Gyeonggi-do (KR); Hong Quang Nguyen, Gyeonggi-do (KR)

(21) Appl. No.: 15/999,182

(22) Filed: Aug. 17, 2018

(30) Foreign Application Priority Data
Dec. 28, 2017 (KR) 10-2017-0181880

(51) Int. Cl. H04L 1/16; H04L 29/06; H04L 12/26; H04L 12/801; H04L 1/18

(52) U.S. Cl. CPC H04L 1/1621; H04L 65/602; H04L 65/607; H04N 21/64738; H04L 43/0829; H04L 47/12; H04L 1/1835; H04L 65/80

(57) ABSTRACT

Provided are a video encoding apparatus using a packet transmission order rearrangement that reduces loss of packets due to network congestion, by rearranging packets arranged in a A_{i,j} matrix, into a Bₖ matrix, via adjustment of a transmission order for each destination, based on the number of all packets for each destination, or by using an arrangement in a one-dimensional (1D) matrix and header points corresponding to the number of destinations, and an operation procedure of the video encoding apparatus.

### CROSS-REFERENCE TO RELATED APPLICATION

This application claims the benefit of Korean Patent Application No. 10-2017-0181880, filed on Dec. 28, 2017, in the Korean Intellectual Property Office, the disclosure of which is incorporated herein in its entirety by reference.

### BACKGROUND

### 1. Field

One or more embodiments relate to technology of sending different numbers of recovery packets for different destinations, based on a packet loss rate for each destination.

### 2. Description of the Related Art

Patent document (Korean Patent No. 10-1240895) discloses an ultra wide band (UWB)-based communication system including a single transmitter and a plurality of receivers, in which the single transmitter generates a packet and transmits the generated packet to the plurality of receivers.

In related-art communication systems, a transmitter can encode the same video and transmit a packet, which is a result of the encoding, to a plurality of receivers in real time, and the plurality of receivers can decode the packet and transmit a video, which is a result of the decoding, to a peripheral device or play the video. For example, assuming that a transmitter is located in Seoul, the transmitter can transmit the same video to receivers of a plurality of domestic destinations such as Incheon, Daejeon, Gwangju, Daegu, and Busan, and can transmit the same video to receivers of a plurality of foreign destinations such as Japan, China, USA, and Europe.

In a related-art 1-to-M transmission and reception structure, a transmitter can transmit a video in units of packets, but high quality or high capacity of the video and network load or congestion can cause packet loss. In addition, due to the packet loss, a video may be destroyed or video flow may be stopped, and it is difficult to recover a lost packet.

For example, in the related art, packets sent by a transmitter may not be properly transmitted to a destination, and some of the packets may be lost on a router.

### SUMMARY

One or more embodiments include a video encoding apparatus that calculates the number of recovery packets for each destination, based on a packet loss rate for each destination, and generates recovery packets corresponding to the number of recovery packets having a maximum value from among the calculated respective numbers of recovery packets for the destinations, and an operation procedure of the video encoding apparatus.

One or more embodiments include a video encoding apparatus that calculates a transmission order of each packet for each destination and rearranges all packets for the destinations in a one-dimensional (1D) matrix, and an operation procedure of the video encoding apparatus.

One or more embodiments include a video encoding apparatus that rearranges a transmission order of the packets for each destination by using an arrangement in the 1D matrix and header pointers corresponding to the number of destinations, and an operation procedure of the video encoding apparatus.

Additional aspects will be set forth in part in the description which follows and, in part, will be apparent from the description, or may be learned by practice of the presented embodiments.

According to one or more embodiments, a video encoding apparatus includes an encoder configured to encode a source video to generate a source packet; a recovery packet generator configured to generate a recovery packet by referring to the number of recovery packets for each destination; and a controller configured to arrange source packets and recovery packets corresponding to each destination in an Ai,j matrix and control a transmission order of packets arranged in the Ai,j matrix, based on the number of all packets for each destination, to thereby rearrange the packets arranged in the Ai,j matrix into a Bk matrix.

The controller may calculate respective transmission order values of the packets arranged in the Ai,j matrix, based on values of the respective numbers of all packets for the destinations, and may rearrange the packets arranged in the Ai,j matrix, into the Bk matrix, according to the calculated transmission order values.

The controller may calculate a least common multiple from the values of the respective numbers of all packets for all the destinations, calculate respective reference values for all the destinations by dividing the calculated least common multiple by each of the values of the respective numbers of all packets for all the destinations, calculate the respective transmission order values of the packets by multiplying each of the respective reference values for all the destinations by each of j index values of the packets, and rearrange the packets into the Bk matrix in an ascending order of the respective transmission order values of the packets.

The video encoding apparatus may further include a buffer configured to temporarily store the source packets and the recovery packets. The controller may calculate the number of recovery packets for each destination, based on a packet loss rate for each destination, and control an operation of the buffer by using information about the calculated number of all packets for each destination.

According to one or more embodiments, a procedure, performed by a video encoding apparatus, of rearranging a transmission order of packets, the procedure including generating a source packet by encoding a source video; generating a recovery packet by referring to the number of recovery packets for each destination; arranging source packets and recovery packets corresponding to each destination in an Ai,j matrix; controlling a transmission order of packets arranged in the Ai,j matrix, based on the number of all packets for each destination; and rearranging the packets arranged in the Ai,j matrix, in a Bk matrix.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a video encoding apparatus according to an embodiment;

FIG. 2 illustrates an example of setting the number of recovery packets for each destination according to a packet loss rate;

FIG. 3 is a schematic diagram illustrating an example in which source packets and recovery packets are arranged in a multi-dimensional layout for each destination in a buffer included in the video encoding apparatus of FIG. 1;

FIG. 4 is a schematic diagram illustrating an example of an operation procedure of the buffer of FIG. 1; and

FIG. 5 is a schematic diagram illustrating another example of an operation procedure of the buffer of FIG. 1.

### DETAILED DESCRIPTION

Reference will now be made in detail to embodiments, examples of which are illustrated in the accompanying drawings, but embodiments are not limited to the descriptions set forth herein.

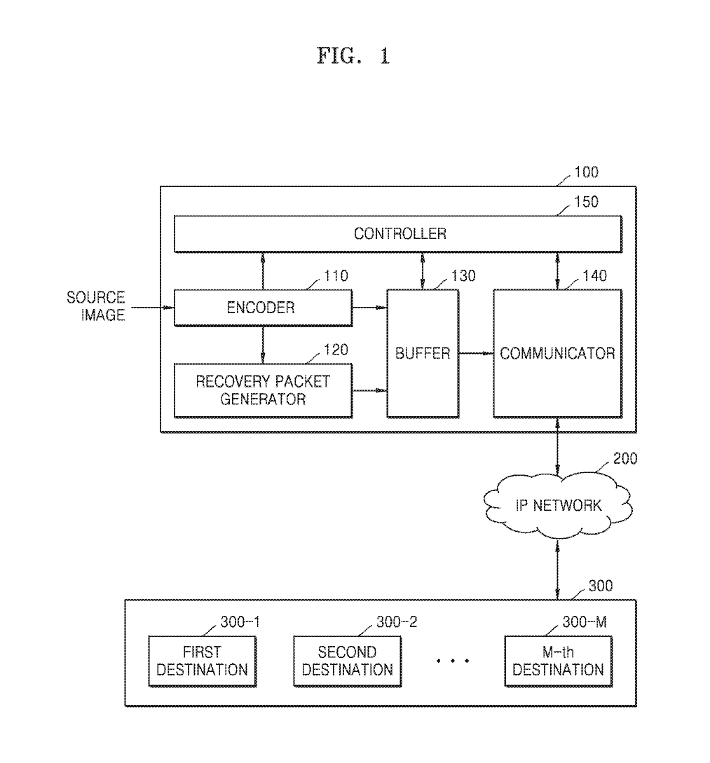

FIG. 1 is a block diagram of a video encoding apparatus 100 according to an embodiment. The video encoding apparatus 100 may communicate with M destinations.

The video encoding apparatus 100 includes an encoder 110, a recovery packet generator 120, a buffer 130, a communicator 140, and a controller 150.

The encoder 110 may generate a source packet by encoding a source video, the recovery packet generator 120 may generate a recovery packet for recovering the source packet, the buffer 130 may temporarily store the source packet and the recovery packet, the communicator 140 may sequentially transmit source packets and recovery packets for each destination stored in the buffer 130 to a destination 300, and the controller 150 may control an operation of each component. The destination 300 may refer to a device that receives a packet from the video encoding apparatus 100.

The source video may be a video received via an external port, such as a high-definition multimedia interface (HDMI) or a serial digital interface (SDI), and may be a video stored in a storage medium.

The recovery packet generator 120 may perform application layer forward error correction (AL-FEC) encoding having systematic code and fountain code characteristics to thereby generate the recovery packet for recovering the source packet. For example, the recovery packet generator 120 may perform RaptorQ AL-FEC encoding to thereby generate the recovery packet for recovering the source packet.

The respective numbers of packets for destinations may be different from each other according to respective different packet loss rates for the destinations.

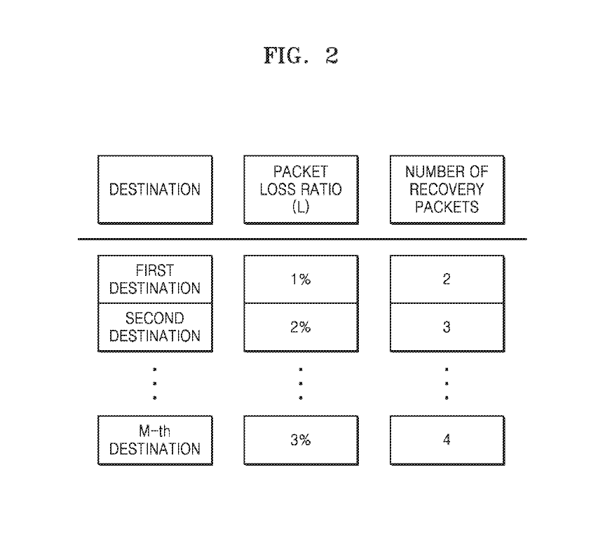

FIG. 2 illustrates an example of setting the number of recovery packets for each destination according to a packet loss rate. The controller 150 calculates the number of recovery packets for each destination and the number of all packets by referring to a packet loss rate for each destination. The number of all packets may mean the number of packets that constitute all the packets. For example, the packets that constitute all the packets may include at least one source packet and at least one recovery packet.

According to the RaptorQ AL-FEC encoding, the controller 150 may calculate the number of recovery packets by using [Equation 1] and [Equation 2]:

r=(Δ+Lk)/(1−L) [Equation 1]

Δ=log₁₀p^{-0.5}−1 [Equation 2]

where r may be the number of recovery packets, L may be a packet loss rate of a transmission network, k may be the number of source packets, and p may be a targeted recovery failure rate. For example, if about one frame recovery failure per one million frames is allowed, then p may be set to be 1/1000000.

The recovery packet generator 120 may generate recovery packets corresponding to the number of recovery packets having a maximum value from among the respective numbers of recovery packets for the destinations. For example, as shown in FIG. 2, the recovery packet generator 120 may generate four recovery packets based on a packet loss rate of 3%, which is the most packets among the respective numbers of recovery packets for the destinations.

The recovery packet generator 120 may allocate to each destination as many recovery packets as necessary.

According to the present disclosure, by considering the packet loss rate for each destination and allocating only as many recovery packets as necessary for each destination to recover a lost packet, a total sum of all recovery packets may be minimized and a lost packet may be effectively recovered in each destination with a decrease in a payload for packet recovery.

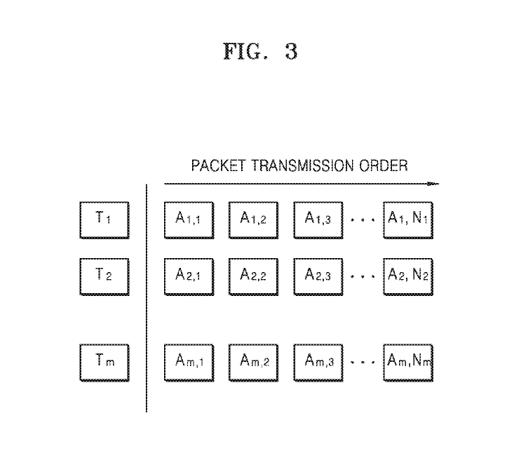

FIG. 3 is a schematic diagram illustrating an example in which source packets and recovery packets are arranged in a multi-dimensional layout for each destination in the buffer 130 of FIG. 1. The respective numbers of packets for destinations may be different from each other according to respective different packet loss rates for the destinations.

According to the present disclosure, T represents a destination and A represents a packet, so the number of all packets in a first destination T1 is N1, the number of all packets in a second destination T2 is N2, and the number of all packets in an m-th destination Tm is Nm.

The buffer 130 may arrange source packets and recovery packets for each destination in an Ai,j matrix and may adjust a transmission order for each destination, based on the number of all packets for each destination, thereby rearranging, in a Bk matrix, the packets arranged in the Ai,j matrix. In the Ai,j matrix and the Bk matrix, i may be an index representing a destination, j may be an index representing a transmission order of packets corresponding to an i-th destination, and k may be an index representing a transmission order of packets when a total of packets in all destinations are rearranged in a 1D manner. Each packet may include indexes respectively indicating a destination and a packet order.

The buffer 130 may calculate a transmission order value of each packet, based on the number of all packets for each destination, and may rearrange, into the Bk matrix, the packets arranged in the Ai,j matrix, according to the calculated transmission order value of each packet.

The buffer 130 may calculate a least common multiple of the values of the respective numbers of all packets for all destinations, calculate a reference value for each destination by dividing the least common multiple by each of the values of the respective numbers of all packets for all the destinations, calculate a transmission order value of each packet by multiplying the reference value for each destination by a j index value, and rearrange the packets into the Bk matrix in an ascending order of the transmission order values.

To rearrange packets into the Bk matrix by comparing the respective transmission order values of the packets, the buffer 130 may compare the transmission order values in units of numbers of destinations, and, when the same transmission order values are generated, may rearrange the packets by referring to i indexes of previously arranged packets.

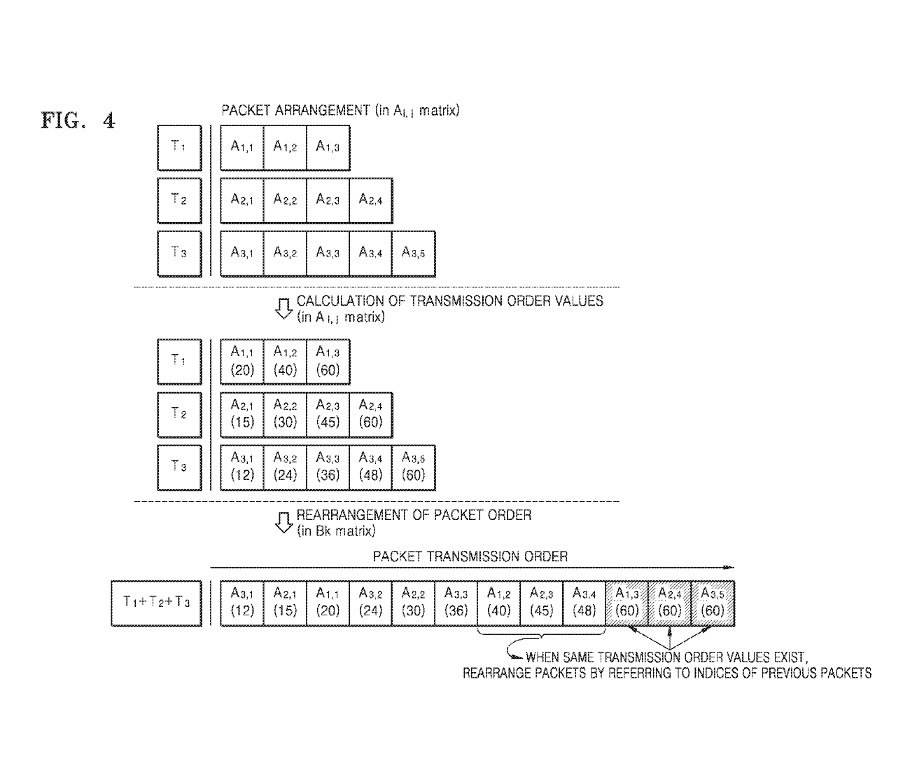

FIG. 4 is a schematic diagram illustrating another example of an operation procedure of the buffer 130 of FIG. 1. The buffer 130 may arrange source packets and recovery packets for each destination. FIG. 4 will now be described supposing that the number of all packets for a first destination T1 is 3, the number of all packets for a second destination T2 is 4, and the number of all packets for a third destination T3 is 5.

The buffer 130 may obtain a least common multiple of 60 from the values of the respective numbers of all packets for the three destinations. The buffer 130 may divide the least common multiple of 60 by each of the values of the respective numbers of all packets for the three destinations T1, T2, and T3, thereby obtaining a reference value of T1 being 20, a reference value of T2 being 15, and a reference value of T3 being 12. The buffer 130 may multiply the reference value for each destination by a j index value, thereby obtaining packet transmission order values {20, 40, 60} for the first destination T1, packet transmission order values {15, 30, 45, 60} for the second destination T2, and packet transmission order values {12, 24, 36, 48, 60} for the third destination T3.

The buffer 130 may rearrange the packets into the Bk matrix in an ascending order of the transmission order values. In other words, the packets of the destinations T1 through T3 may be rearranged in a packet order of {A3,1(12), A2,1(15), A1,1(20), A3,2(24), A2,2(30), A3,3(36), A1,2(40), A2,3(45), A3,4(48), A1,3(60), A2,4(60), A3,5(60)}.

To rearrange the packets into the Bk matrix by comparing the respective transmission order values of the packets, the buffer 130 may compare the transmission order values in units of numbers of destinations, and, when the same transmission order values as in A1,3(60), A2,4(60), A3,5(60) are generated, may rearrange the packets by referring to respective i indexes of previously arranged packets A1,2(40), A2,3(45), and A3,4(48).

The buffer 130 may remove, from a group of packets having the same transmission order values, a packet that is on the same row as a last packet from among previous packets rearranged in an earlier order than the group. The buffer 130 may also remove, from the group, a packet that is on the same row as a next last packet from among the previous packets rearranged in an earlier order than the group. The buffer 130 may sequentially remove the packets within the group according to this procedure until there remains last one packet in the group, and may arrange the packet next to the packets arranged in the earlier order than the group. For example, when a last value of Bk is A3,4(48), the buffer 130 may remove A3,5(60), which is on the same row as A3,4(48), from a group of the packets A1,3(60), A2,4(60), and A3,5(60) having the same transmission order values, may remove A2,4(60), which is on the same row as A2,3(45), which is a next last value, from the group, and may select one last remaining packet A1,3(60) from the group and arrange the last remaining packet A1,3(60) next to A3,4(48).

According to the present disclosure, the communicator 150 may sequentially transmit the packets rearranged into the Bk matrix, via an IP network 200.

According to the present disclosure, a transmission order of packets that are to be transmitted to each destination is adjusted, the packets are rearranged in the adjusted transmission order, and a transmission interval of packets that reach each destination is increased, resulting in a reduction of loss of packets due to network congestion.

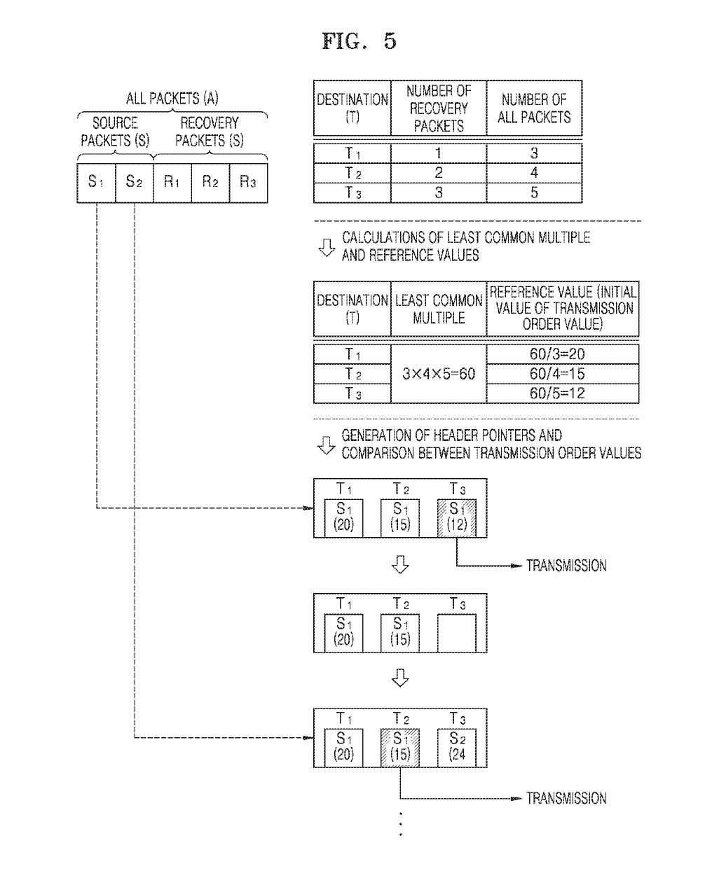

FIG. 5 is a schematic diagram illustrating another example of an operation procedure of the buffer 130 of FIG. 1. The buffer 130 may rearrange a transmission order of packets for each destination by using only header pointers corresponding to the number of destinations, without using an arrangement in the Ai,j matrix or the Bk matrix corresponding to the number of destinations, shown in FIG. 4, and may minimize usage of a memory. The respective numbers of source packets for the destinations may be equal to each other, and the respective numbers of recovery packets for the destinations may be different from each other.

The buffer 130 may sequentially arrange source packets, the number of which allocated for each destination is the same, and recovery packets, the number of which is maximum from among the respective numbers of recovery packets for the destinations, and may generate header pointers corresponding to the number of destinations.

The buffer 130 may arrange a header including destination information and a transmission order value of a first packet of each destination in each header pointer, by referring to the transmission order value of each packet calculated based on the number of all packets for each destination.

The buffer 130 may compare the transmission order values, based on the headers respectively arranged on the header pointers, may select a header pointer including a header with a minimum transmission order value, and, when a packet including the header arranged in the selected header pointer is transmitted, may empty the selected header pointer. The communicator 140 may transmit a packet to a destination by referring to destination information included in the header of the packet.

The buffer 130 rearranges a next header in the emptied header pointer and selects again a header pointer including the header of a minimum transmission order value.

As described above with reference to FIG. 4, the operation procedure of the buffer 130 is the same as the procedure of calculating the transmission order value of a packet, comparing transmission order values in units of numbers of destinations, and controlling an order when the same transmission order values are generated.

As shown in FIG. 5, it will be assumed that there are three destinations, the respective numbers of source packets for the three destinations are all 2, three packets are allocated to the first destination T1, four packets are allocated to the second destination T2, and five packets are allocated to the third destination T3.

Referring to FIG. 5, all packets A may include two source packets S and three recovery packets R, wherein the number of recovery packets R is equal to the number of recovery packets corresponding to the third destination T3 having a largest number of recovery packets. The buffer 130 may sequentially arrange as the five packets (two source packets and three recovery packets) included in all the packets A and may generate three header pointers corresponding to the number of destinations.

The buffer 130 may arrange a header including destination information and a transmission order value of a first packet of each destination in each header pointer, by referring to the transmission order value of each packet calculated based on the number of all packets for each destination. A procedure of calculating the transmission order values of the packets may be achieved by the above-described calculations of a least common multiple and reference values.

The buffer 130 may compare transmission order values included in headers respectively arranged in the header pointers, select a first packet S1(12) of a header pointer T3 in which the header of a minimum transmission order value has been arranged, empty the header pointer when the first packet S1(12) is transmitted, and rearrange a next header S2(24) in the emptied header pointer. A transmission order value or an initial value corresponding to a first packet for each destination may be a reference value, and a transmission order value corresponding to a next packet may be calculated by multiplying the reference value by an index value of the next packet.

The buffer 130 may compare again the transmission order values corresponding to destination numbers arranged in the three header pointers, select a first packet S1(15) of a header pointer T2 of a minimum transmission order value, and repeat the above-described operation.

The buffer 130 may repeat the operations of rearranging headers, comparing transmission order values of header pointers, selecting a header pointer including a minimum transmission order value, transmitting a packet of the selected header pointer, emptying the selected header pointer, thereby transmitting all packets corresponding to all of the destinations, may minimize usage of the memory and may adjust a transmission order for each destination to thereby reduce loss of packets due to network congestion.

Although it has been described above that the buffer 130 performs several operations for reducing loss of packets, embodiments are not limited thereto. The buffer 130 may temporarily store data, and the controller 150 may perform the above-described several operations of the buffer 130.

According to the present disclosure, by considering the packet loss rate for each destination and allocating only as many recovery packets as necessary for each destination to recover a lost packet, a total sum of all recovery packets may be minimized and a lost packet may be effectively recovered in each destination with a decrease in a payload for packet recovery.

According to the present disclosure, a transmission order for each destination is adjusted, and thus loss of packets due to network congestion may be reduced.

According to the present disclosure, loss of packets due to network congestion may be reduced by using only a layout in a 1D matrix and a header pointer corresponding to the number of destinations, and also usage of memory of a buffer may be minimized.

Some embodiments may also be embodied as a storage medium including instruction code executable by a computer such as a program module executed by the computer. A medium can be any available medium which can be accessed by the computer and includes all volatile/non-volatile and removable/non-removable media. Further, the computer-readable medium may include computer storage and communication media. The computer storage medium includes all volatile/non-volatile and removable/non-removable media embodied by a certain procedure or technology for storing information such as computer-readable instruction code, a data structure, a program module or other data.

Although the embodiments of the present disclosure have been disclosed for illustrative purposes, one of ordinary skill in the art will appreciate that diverse variations and modifications are possible, without changing the technical spirit or essential features of the disclosure. Thus, the above examples should be understood not to be restrictive but to be illustrative, in all aspects.

While one or more example embodiments have been described with reference to the figures, it will be understood by those of ordinary skill in the art that various changes in form and details may be made therein without departing from the spirit and scope as defined by the following claims.

What is claimed is:

1. A video encoding apparatus comprising:
an encoder configured to encode a source video to generate a source packet;
a recovery packet generator configured to generate a recovery packet by referring to the number of recovery packets for each destination; and
a controller configured to arrange source packets and recovery packets corresponding to each destination in an Ai,j matrix and control a transmission order of packets arranged in the Ai,j matrix, based on the number of all packets for each destination, to thereby rearrange the packets arranged in the Ai,j matrix into a Bk matrix,
wherein i is an index representing a destination, j is an index representing a transmission order of packets corresponding to an i-th destination, and k is an index representing a transmission order of packets when a total of packets in all destinations are rearranged in a one-dimensional (1D) manner.

2. The video encoding apparatus of claim 1, wherein the controller calculates respective transmission order values of the packets arranged in the Ai,j matrix, based on values of the respective numbers of all packets for the destinations, and rearrange the packets arranged in the Ai,j matrix, into the Bk matrix, according to the calculated transmission order values.

3. The video encoding apparatus of claim 2, wherein the controller is further configured to calculate a least common multiple from the values of the respective numbers of all packets for all the destinations, calculate respective reference values for all the destinations by dividing the calculated least common multiple by each of the values of the respective numbers of all packets for all the destinations, calculate the respective transmission order values of the packets by multiplying each of the respective reference values for all the destinations by each of j index values of the packets, and rearrange the packets into the Bk matrix in an ascending order of the respective transmission order values of the packets.

4. The video encoding apparatus of claim 1, further comprising a buffer configured to temporarily store the source packets and the recovery packets,
wherein the controller is further configured to calculate the number of recovery packets for each destination, based on a packet loss rate for each destination, and control an operation of the buffer by using information about the calculated number of all packets for each destination.

5. A procedure, performed by a video encoding apparatus, of rearranging a transmission order of packets, the procedure comprising:
generating a source packet by encoding a source video;
generating a recovery packet by referring to the number of recovery packets for each destination;
arranging source packets and recovery packets corresponding to each destination in an Ai,j matrix;
controlling a transmission order of packets arranged in the Ai,j matrix, based on the number of all packets for each destination; and
rearranging the packets arranged in the Ai,j matrix, into a Bk matrix,
wherein i is an index representing a destination, j is an index representing a transmission order of packets corresponding to an i-th destination, and k is an index representing a transmission order of packets when a total of packets in all destinations are rearranged in a one-dimensional (1D) manner.
